(19) United States
(12) Patent Application Publication
(10) Pub. No.: US 2025/0037696 A1
(43) Pub. Date: Jan. 30, 2025

(54) DEVICE FOR ACTIVE NOISE SUPPRESSION AND/OR OCCLUSION SUPPRESSION, CORRESPONDING METHOD, AND COMPUTER PROGRAM

(71) Applicant: ELEVEAR GMBH, Aachen (DE)

(72) Inventors: Johannes FABRY, Aachen (DE); Stefan LIEBICH, Aachen (DE); Raphael BRANDIS, Aachen (DE)

(21) Appl. No.: 18/715,974

(22) PCT Filed: Dec. 7, 2022
(86) PCT No.: PCT/EP2022/084751

§ 371 Date: Jun. 3, 2024

(30) Foreign Application Priority Data
Dec. 9, 2021 (DE) 10 2021 132 434.3

(51) Int. Cl. G10K 11/178; H04R 1/10

(52) U.S. Cl. CPC G10K 11/17853; H04R 1/1016

(57) ABSTRACT

In the apparatus an earpiece is provided which can be coupled to a user's ear canal. An inner microphone in the earpiece is configured to detect a sound signal in the user's ear canal. A loudspeaker in the earpiece is configured to output a compensation signal into the user's ear canal. A signal processor is connected to the inner microphone and the loudspeaker in such a way that a feedback loop is formed. The signal processor is configured to apply two or more feedback filters or a feedback filter resulting from two or more feedback filters to an input signal in the feedback loop, wherein the individual feedback filters have different effects on the attenuation characteristics of the feedback loop and are each designed to suppress different sound components, wherein the two or more feedback filters are combined by a mixture. An intermediate signal generated by using the two or more feedback filters or the feedback filter resulting from two or more feedback filters is supplied to the loudspeaker The input signal supplied to the two or more feedback filters is calculated from the signal of the inner microphone corrected by the intermediate signal filtered by a secondary path estimate

The present disclosure relates to an apparatus for active noise and/or occlusion suppression and a corresponding method, in particular for use when playing audio signals with headphones. The present disclosure further relates to a computer program with instructions that cause a computer to carry out the steps of the method.

Nowadays, headphones often have additional functions in addition to playing audio, such as a wireless connection to a mobile device or active noise cancellation (ANC). Such headphones are often referred to as hearables or intelligent headphones. In order to provide good bass reproduction and passive sound attenuation, most hearables are designed as closed in-ear headphones, where the headphones are inserted into the opening of the ear canal during use and rest against its inner wall. For example, music can be played through the headphones or the voice of a caller can be played during a phone call using the headphones without noticeable interference from the environment.

However, closing off the ear canal with closed headphones causes the occlusion effect, which leads in particular to a muffled perception of one's own voice. The muffled perception of one's own voice is due on the one hand to the fact that the high-frequency components of one's own voice transmitted through airborne sound are significantly weakened by the headphones or hearing aid closing off the ear canal. On the other hand, the low-frequency components of one's own voice are also transmitted into the ear canal in the form of structure-borne sound, particularly via bone and cartilage tissue, and cannot or can only partially escape from the ear canal due to the closure. In this way, the low-frequency components are amplified compared to the high-frequency components. This occlusion effect, which is often perceived as unpleasant, occurs for any structure-borne sound, for example in addition to one's own voice also for chewing and swallowing noises and one's own impact sound.

To compensate for the occlusion effect, different approaches are proposed in the prior art. The ear canal can be ventilated directly, such as through the small air channels common in hearing aids, or open headphones can be used, which do not completely close off the ear canal. Another approach is the active generation of a counter-sound signal, which is played back via the headphones' loudspeaker and destructively superimposed on the structure-borne sound signal. For example, EP 1 537 759 A1 describes a method for compensating for occlusion effects, in which this counter-sound signal is generated based on the signal from the inner microphone of the headphones, which detects sound signals in the user's ear canal. A feedback loop is formed through the transmission from the inner microphone of the headphones via a signal processor to the loudspeaker and the acoustic coupling of the inner microphone and the loudspeaker to the user's ear canal. A method for designing a controller that stabilizes this feedback loop based on a predetermined, fixed target function is described, for example, in EP 3 520 441 A1.

Such a controller is designed according to the state of the art for a fixed target function. If further applications requiring other target functions are to be taken into account in the design, this is only possible to a limited extent, for example by forming the mean value over all target functions to be taken into account. These limitations can mean that the controller does not deliver satisfactory performance for all applications and therefore only represents a compromise solution that is of limited use.

The disclosed embodiments provide an apparatus for active noise and/or occlusion suppression and a corresponding method, as well as a computer program for carrying out the method.

In the disclosed apparatus for active noise and/or occlusion suppression, an earpiece is provided which can be coupled to a user's ear canal. An inner microphone arranged in the earpiece is configured to detect a sound signal in the user's ear canal. A loudspeaker arranged in the earpiece is configured to output a compensation signal into the user's ear canal, wherein noise and/or the occlusion effect can be reduced with the compensation signal. Furthermore, the apparatus has a signal processor which is connected to the inner microphone and the loudspeaker in such a way that a feedback loop is formed. The signal processor is configured to apply two or more feedback filters or a feedback filter resulting from two or more feedback filters to an input signal in the feedback loop, wherein the individual feedback filters have different effects on the attenuation characteristics of the feedback loop and are each designed to suppress different sound components of the noise and/or the occlusion effect, and wherein the two or more feedback filters are combined by a mixture. An intermediate signal generated by applying the two or more feedback filters or the feedback filter resulting from two or more feedback filters is supplied to the loudspeaker. The input signal supplied to the two or more feedback filters or the feedback filter resulting from two or more feedback filters is calculated from the signal of the inner microphone corrected by the intermediate signal filtered by a secondary path estimate.

By mixing two or more feedback filters in this way, it is possible to adapt to the current acoustic conditions. This adaptation brings advantages in the active suppression of noise and/or the occlusion effect, since the feedback filters can be optimized for different situations and applications. The feedback filters can either be optimized directly or calculated from optimized controllers. To suppress the occlusion effect, for example, a controller can be designed for parts of the own voice and another controller can be designed for parts of impact sound, after which these controllers can be converted into feedback filters. The controllers or the feedback filters should affect the feedback loop in such a way that the feedback loop has a high attenuation for the own voice, for example in the range between 100 and 300 Hz, and for impact sound, for example in the range between 20 and 100 Hz. By mixing, it can not only be switched back and forth between feedback filters, but also several feedback filters can be combined. This is advantageous for chewing and swallowing noises, for example, which may be higher in frequency than impact sound but lower in frequency than speech. It is also possible to adapt to different fundamental frequencies of the own voice, for example. The basic frequency of one's own voice is on average between 100 and 150 Hz for men, between 190 and 250 Hz for women and between 350 and 500 Hz for children. By mixing the feedback filters, an adjustment can be made to different speakers. For the application of active noise suppression, in which external noises are to be suppressed as much as possible, the approach is also advantageous because, for example, aircraft noise affects different frequency ranges than road noise.

According to one embodiment, the mixing of the two or more feedback filters is carried out by the signal processor of the apparatus.

According to a further embodiment, the mixing of the two or more feedback filters is performed by a digital processing device implemented in an external device.

Furthermore, the resulting attenuation characteristics are advantageously adjusted by weighting the individual feedback filters.

According to a further embodiment, the apparatus for reproducing external audio signals has an equalizer through which the external audio signals are processed, the intermediate signal being generated from the output signal of the feedback filters combined by the mixture and the audio signal filtered by the equalizer.

According to a further embodiment, the apparatus has one or more forward filters, to which the signals are fed from one or more outer microphones arranged in the earpiece, which are configured to detect airborne sound signals outside the user's ear canal, wherein the output signals of the forward filter are also taken into account when generating the intermediate signal.

The weighting of the individual feedback filters can advantageously be set manually.

Likewise, the weighting of the individual feedback filters can advantageously be set automatically by a calculation unit.

Furthermore, the calculation unit can preferably provide a weighting function for each individual feedback filter followed by a power estimate, which is then normalized and smoothed in order to calculate a weighting factor.

It is advantageous if the weighting factors for the individual feedback filters are calculated so that they add up to a predefined value.

It can also be advantageous if the calculated weighting factors are multiplied by another factor, this factor coming from another calculation unit.

Furthermore, in one embodiment it can be provided that the apparatus recognizes different wearing situations, in particular different ventilations, and the calculation unit adapts the weighting factors accordingly.

In addition, in one embodiment it can be provided that the filtering of at least one of the feedback filters is carried out at a first sampling rate and the filtering of at least one further feedback filter is carried out at a second sampling rate which is different from the first sampling rate, wherein the input and output signals of this Filters undergo a sampling rate conversion.

The apparatus can in particular be part of a headphone, hearing aid or hearing protection.

Accordingly, in a disclosed method for active noise and/or occlusion suppression, in which an earpiece is coupled to the ear canal of a user, the following steps are carried out:
Detecting a sound signal occurring in the user's ear canal with an inner microphone arranged in the earpiece;
applying two or more feedback filters or a feedback filter resulting from two or more feedback filters in a feedback loop to an input signal, the individual feedback filters having different effects on the attenuation characteristics of the feedback loop and each being designed to suppress different sound components of the noise and/or the occlusion effect; the two or more feedback filters being combined by a mixture, the input signal fed to the two or more feedback filters or to the feedback filter resulting from two or more feedback filters being calculated from the signal of the inner microphone, corrected by the intermediate signal filtered by a secondary path estimate, and an intermediate signal generated by the application of the two or more feedback filters or the feedback filter resulting from two or more feedback filters being fed to the loudspeaker; and
Outputting a compensation signal generated in this way into the user's ear canal through a loudspeaker arranged in the earpiece, wherein the compensation signal is used to reduce background noise and/or the occlusion effect.

The disclosure also relates to a computer program with instructions that cause a computer to carry out the steps of the disclosed method.

Further features of the present disclosure will become apparent from the following description and the claims in conjunction with the figures.

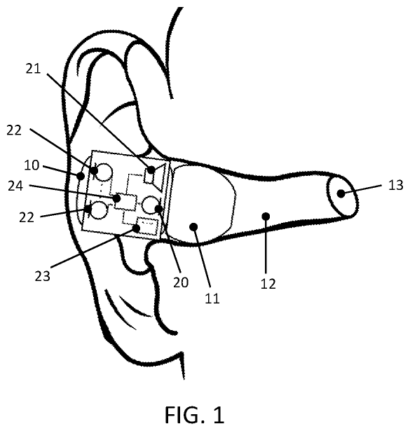

FIG. 1 schematically shows an in-ear headphone in the ear canal of a user with essential electronic components;

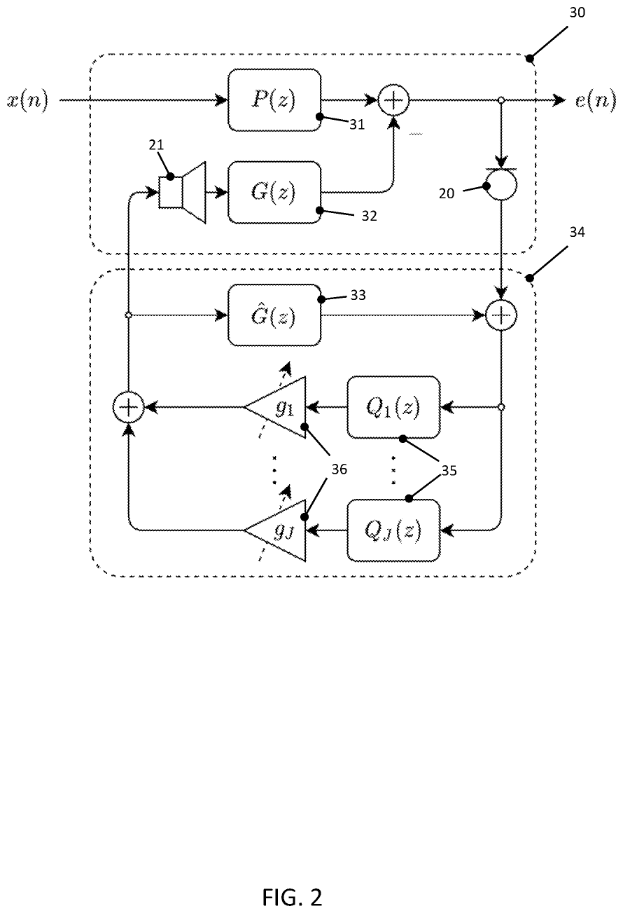

FIG. 2 shows a block diagram of an apparatus according to the disclosure with a feedback structure with several controllers;

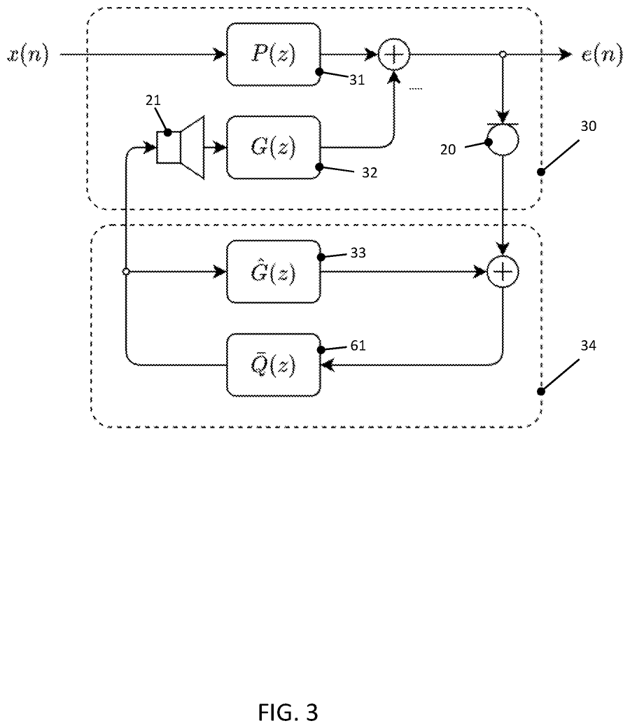

FIG. 3 shows a block diagram of a feedback structure with only one controller resulting from the mixture of several controllers according to the disclosure;

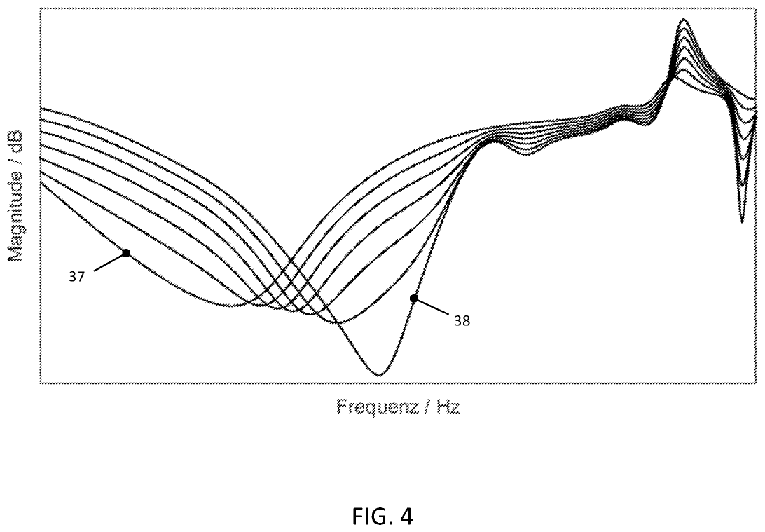

FIG. 4 shows a transition of the attenuation behavior of a feedback loop at the transition between two feedback filters;

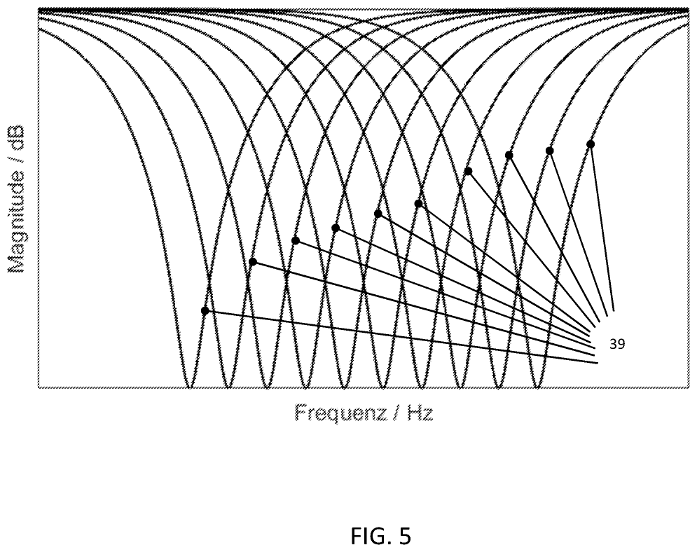

FIG. 5 schematically shows a set of target functions with different center frequencies;

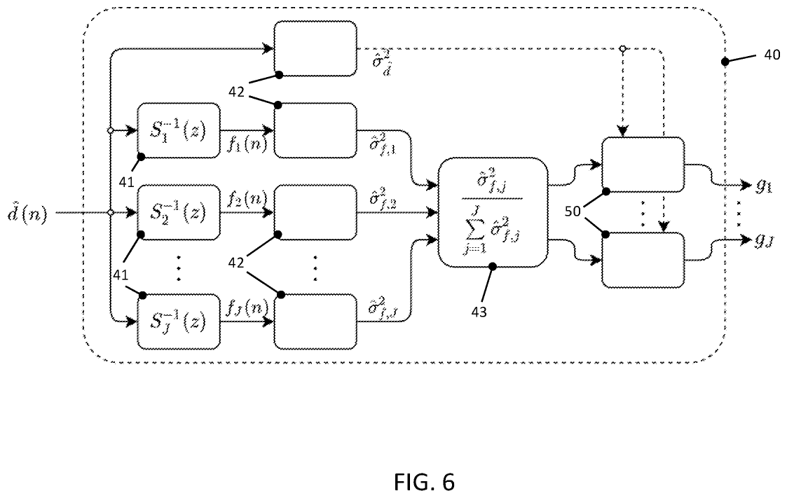

FIG. 6 shows a process flow for calculating several weighting factors;

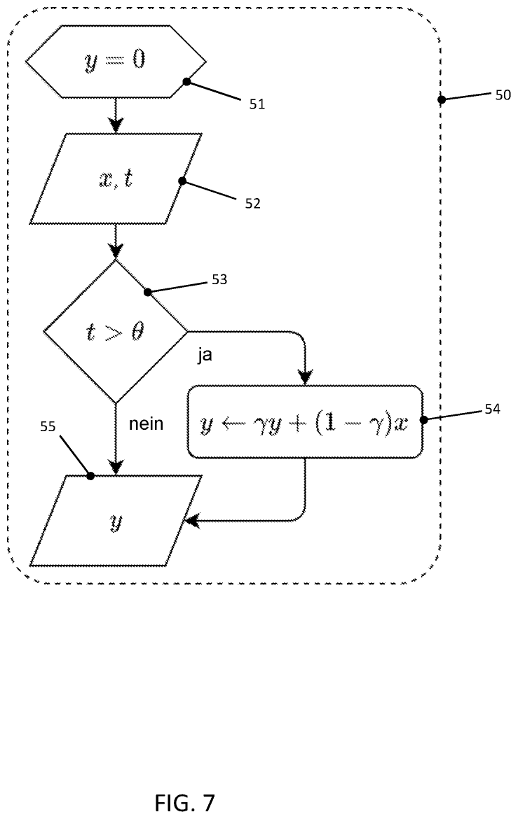

FIG. 7 shows a process flow for conditionally smoothing a signal;

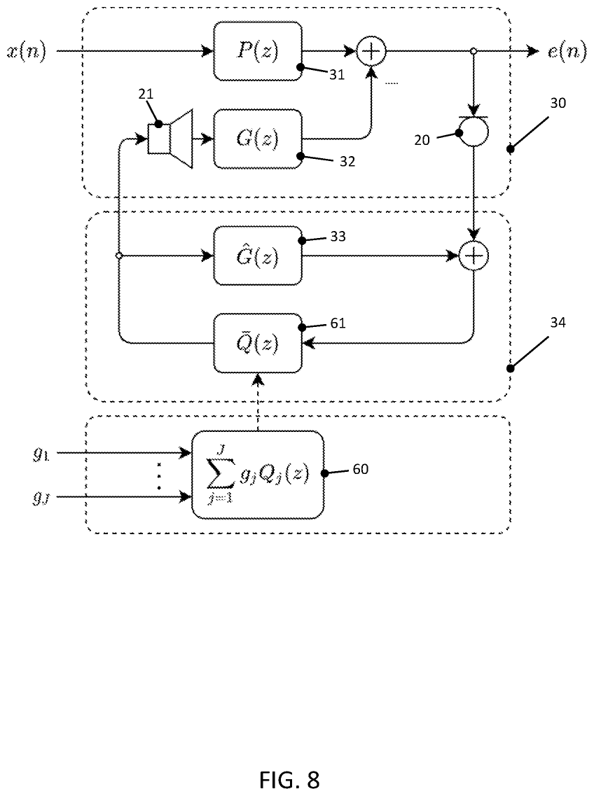

FIG. 8 shows a feedback structure with a feedback filter and external adjustment;

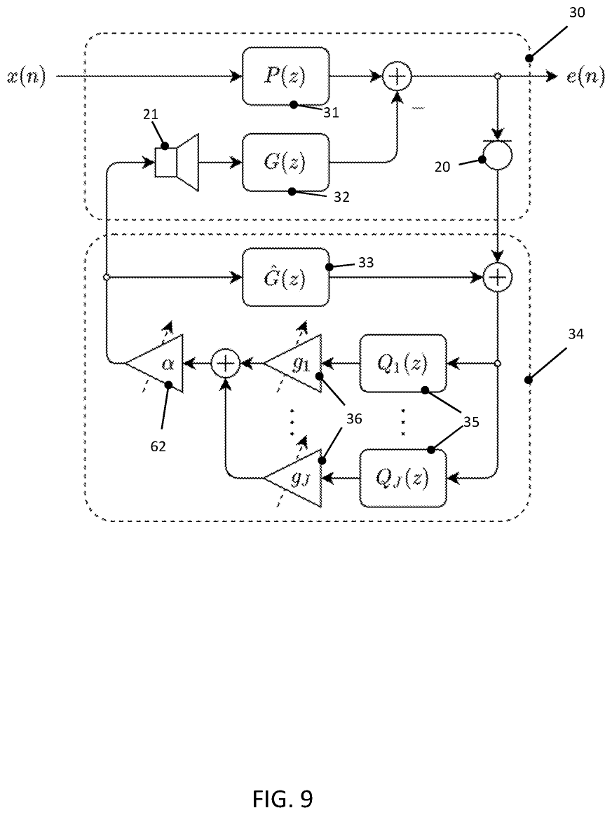

FIG. 9 shows a feedback structure with multiple feedback filters and overall scaling;

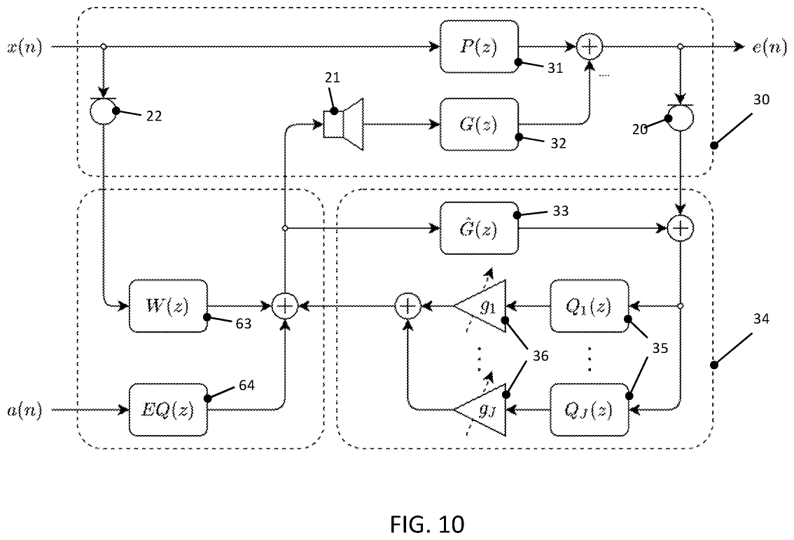

FIG. 10 shows a hybrid structure with multiple feedback filters;

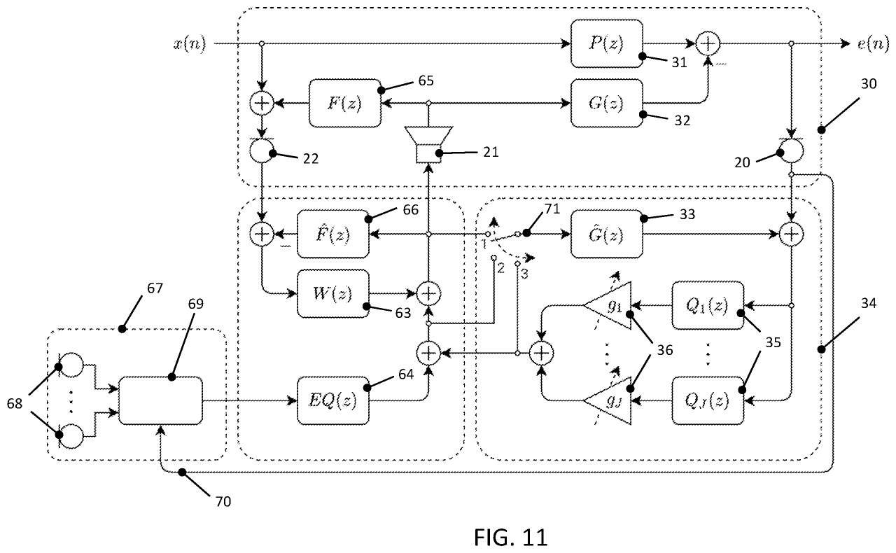

FIG. 11 shows a hybrid structure with a hearing instrument;

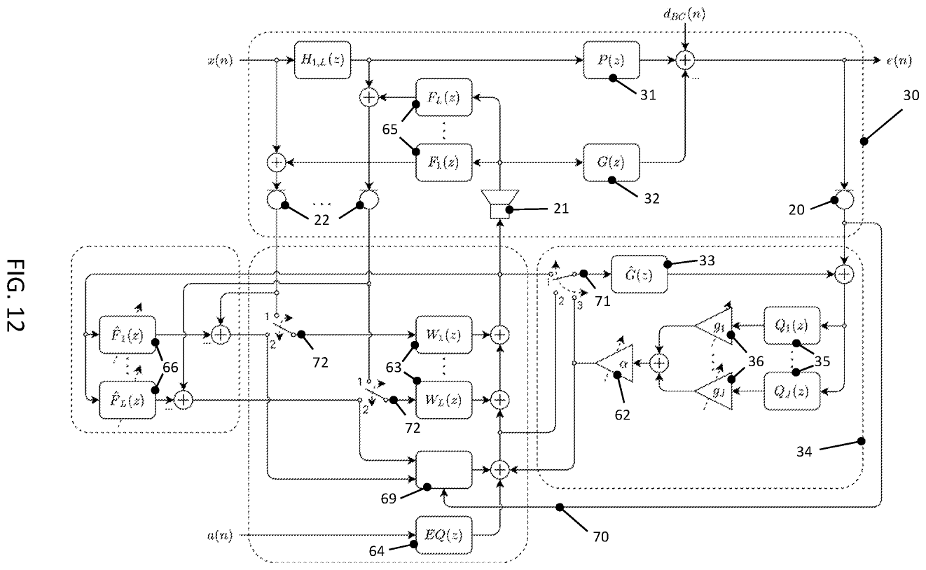

FIG. 12 shows a hybrid structure with integrated hearing aid functionality; and

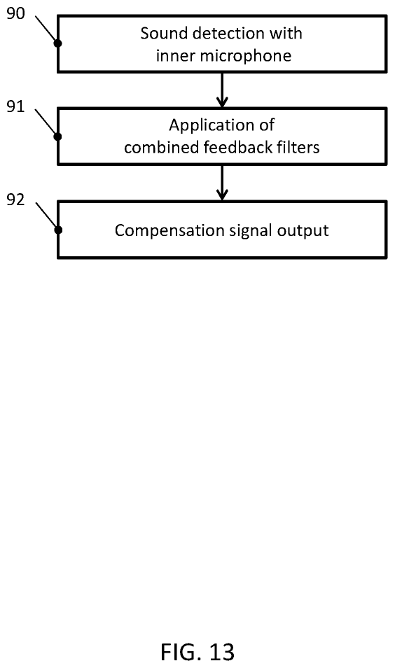

FIG. 13 shows a flow chart of a method according to the disclosure.

For a better understanding of the principles of the present disclosure, embodiments are explained in more detail below with reference to the figures. It is understood that the disclosure is not limited to these embodiments and that the described features can also be combined or modified without departing from the scope of the disclosure as defined in the claims.

FIG. 1 shows an example of an in-ear headphone for using the disclosed apparatus. The in-ear headphones 10 are located on the ear of a user, with an ear insert 11 of the in-ear headphones being inserted into the external auditory canal 12 in order to keep them in place. Depending on the individual fit in the ear canal and the material, the ear insert seals the ear canal to a certain extent. As a result, external sound is passively attenuated to a certain extent by the in-ear headphones when transmitted to the eardrum 13. The degree of attenuation depends on how tightly the ear insert 11 closes off the ear canal 12 and what material it is made of. Furthermore, sealing the ear canal 12 by an ear insert 11 makes it more difficult for structure-borne sound, which is emitted into the ear canal 12 by vibrating ear canal walls, to escape from the ear canal. This often manifests itself in an audible amplification of low frequency components of structure-borne sound compared to an open ear canal.

FIG. 1 also shows the electronic components of an in-ear headphone that are essential to the disclosure. The headphone 10 is equipped with at least one inner microphone 20 for recording the signal in the ear canal 12 and at least one loudspeaker 21 for playing back external audio signals, such as music or the voice of the other party during a telephone call, as well as a compensation signal. The headphone can also have several outer microphones 22 that are attached to the outside of the headphone to record airborne sound signals. The headphone can also be equipped with one or more acceleration sensors 23 to detect vibrations that are transmitted to the headphone via the ear canal 12. The headphone 10 is also equipped with a signal processor 24 that processes the signals from the microphones 20, 22 and vibration sensors 23 to generate a compensation signal and feeds this together with the external audio signals to the loudspeaker 21. Even though digital signal processing may require analog-to-digital converters to digitize the sound signals captured by the microphones and vibration sensors and digital-to-analog converters to convert the output signal of the signal processor for playback via the loudspeaker, these are not shown in the figures for the sake of simplicity. Likewise, only the conceptual structure is shown in relation to one ear, although in-ear headphones are usually provided with sound transducers for both ears of the user.

FIG. 2 shows a block diagram of a feedback structure with several feedback filters 35 for an apparatus according to the disclosure, which can be used, for example, for an in-ear headphone shown in FIG. 1. Due to the digital signal processing, the signals are considered below in the time domain with a discrete time index n. The z-transformation with the variable z is used for the frequency domain representation of time-discrete signals and filters.

In the upper area of FIG. 2, an acoustic model 30 is shown for a sound signal arriving at the headphones from the environment x(n), which can contain in particular the user's voice, but also ambient noise. Here, the sound signal x(n) detected by the at least one outer microphone 22 from FIG. 1 is transmitted via the acoustic primary path P(z) 31, the primary path P(z) describing the acoustic transfer function from the at least one outer microphone 22 to the inner microphone 20. A compensation signal is output from the loudspeaker 21, with the acoustic secondary path G(z) 32 describing the transfer function from the loudspeaker 21 to the inner microphone 20.

The input signal of the feedback filter 35 is composed of the signal of the inner microphone 20 corrected by an intermediate signal filtered by a secondary path estimate 33. In FIG. 2, the intermediate signal corresponds to the sum of the output signals of the feedback filters 35 weighted by the weighting units 36. In this case, the intermediate signal is also supplied to the loudspeaker 21 and corresponds to the compensation signal. The filtering, weighting and summation can be carried out, for example, on a signal processor 24 from FIG. 1. The individual feedback filters 35 each have a different effect on the attenuation characteristics of the feedback loop and are each designed to suppress different sound components of the background noise and/or the occlusion effect. A change in the mixing ratio, here through the weighting unit 36, therefore also has an effect on a change in the attenuation characteristics of the feedback loop.

For a design process of the individual feedback filters 35, measurements of the secondary path 32 G(z), which describes the transfer function from an output of a digital signal processor 24 via the loudspeaker 21 and the inner microphone 20 of the headphones to an input of the same processor, are necessary. The secondary path can be measured, for example, for an artificial head or people by playing a measurement signal through the loudspeaker of a headphone connected to the signal processor and recording it through the inner microphone of this headphone. The secondary path can then be estimated from the played and recorded signal, for example by spectral division. In order to ensure the stability of the feedback filters to be designed, the number of secondary paths must be comprehensive enough to be able to model all situations that could potentially occur in an end application. It is therefore advisable to measure not only secondary paths in which a headphone is worn firmly in the ear canal 12, but also secondary paths for other cases that occur in the application, for example when the headphone is held in the hands or inserted into the ear.

According to the disclosure, a combination of/discrete, robust feedback filters Qⱼ(z) with j=1, . . . , J is used. These feedback filters can either be designed directly, by methods known to the skilled person and taking into account headphone or secondary path measurements. Alternatively, controllers Kⱼ(z) can first be designed using methods familiar to the skilled person and taking into account headphone or secondary path measurements, which can then be converted into the feedback filters Qⱼ(z) depending on an estimate Ĝ(z) 33 of the secondary path 32 using the rule

$${Q}_{j} ( z ) = \frac{{K}_{j} ( z )}{1 + \hat{G} ( z ) {K}_{j} ( z )} . \qquad ( 1 )$$

Each of these feedback filters is designed for a different target function Sⱼ(z). As previously explained, for example, one feedback filter can be designed to compensate for the occlusion effect for speech and another feedback filter can be designed to compensate for the occlusion effect for impact sound. The feedback filters can also be designed for different external noise or for different levels of fitting.

FIG. 3 shows in simplified form the implementation of a single feedback filter Q(z) 61, which is based, for example, on a mixture of several feedback filters using

$$\overline{Q} ( z ) = {\sum }_{j = 1}^{J} {g}_{j} \cdot {Q}_{j} ( z ) \qquad ( 2 )$$

The feedback filter Q(z) is implemented in a so-called Internal Model Control (IMC) structure. The output signal of the feedback filter 61 is convolved with a secondary path estimate Ĝ(z) 33 and offset against the signal of the inner microphone 20. With the IMC structure from FIG. 3, the transfer function from the inner microphone to the loudspeaker corresponds to the controller

$$\overline{K} ( z ) = \frac{\overline{Q} ( z )}{1 - \hat{G} ( z ) \overline{Q} ( z )} . \qquad ( 3 )$$

The IMC structure thus implicitly reverses equation (1) and transfers the mixed feedback filter Q̅(z) into the controller K(z).

The attenuation characteristic of the feedback loop is determined depending on a single feedback filter Qⱼ(z) as

$${S}_{j} ( z ) = \frac{1 - \hat{G} ( z ) {Q}_{j} ( z )}{1 + ( G ( z ) - \hat{G} ( z ) ) {Q}_{j} ( z )} . \qquad ( 4 )$$

The attenuation characteristic provides information about the attenuation and amplification of the inner microphone signal with the reproduction of a compensation signal relative to the inner microphone signal without the reproduction of a compensation signal. The effective attenuation characteristic of the closed feedback loop results with the mixed feedback filter Q̅ⱼ(z) 61 as

$$S ( z ) = \frac{1 - \hat{G} ( z ) \overline{Q} ( z )}{1 + [ G ( z ) - \hat{G} ( z ) ] \overline{Q} ( z )} . \qquad ( 5 )$$

When designing feedback filters, the attenuation characteristic of the feedback loop represents a target function.

The weighting factors gⱼ ensure, for example for J=2, with

$$0 \leq {g}_{j} \leq 1 \qquad ( 6 )$$

$${\sum }_{j = 1}^{J} {g}_{j} = 1 \qquad ( 7 )$$

for an interpolation of the attenuation characteristics of two controllers, as shown in FIG. 4. In this case, both the attenuation characteristic 37 of the target function S₁(z) and the attenuation characteristic 38 of the target function S₂(z) can be realized, as well as attenuation characteristics whose attenuation center of gravity lies on the frequency axis between the attenuation centers of gravity of the target functions S₁(z) and S₂(z). In contrast to equation (7), the sum of the weighting factors can also result in values less than one, which leads to a reduced attenuation of the feedback loop. This can be relevant, for example, if the occlusion effect is reduced due to a poor fitting of headphones so that a correspondingly lower degree of compensation is necessary. Likewise, the sum of the weighting factors can also result in values greater than one in order to strengthen the attenuation characteristics of the feedback loop, for example if the occlusion effect is particularly strong in one person.

According to the disclosure, a set of feedback filters can be designed for a set of target functions 39, as shown in FIG. 5, for example based on a parametric equalizer with different center frequencies. The weights gⱼ can be determined automatically at runtime by the disclosed apparatus, which is implemented, for example, in a headphone. The progression of the weights over time can be both abrupt and continuous. However, these can also be determined on a separate device, such as a smartphone, and transmitted to the device for use in noise or occlusion suppression. Furthermore, the weighting factors can be set manually. The weighting factors gⱼ can be adjusted either manually by users at runtime, by a calibration process or by experts to meet customer requirements, for example by audiologists as part of a service. The weighting factors can be set, for example, using setting elements on the headphones or by inputting into a control program implemented on a smartphone or other mobile device. For example, a slider displayed on a display device can be used, which in the simple case of J=2 selects, depending on the position of a displayed marking, values between 0 and 1 for g₁ and g₂ depending on g₁ as g₂=1−g₁.

FIG. 6 shows a process flow 40 for automatically calculating the weighting factors. The estimated interference signal \hat{d}(n), which corresponds to the input signal of the feedback filters, is first filtered by a set of filters 41. The filters 41 implement the inverse Sⱼ⁻¹(z) of each transfer function Sⱼ(z) from a set of target functions, such as the target functions 39 shown in FIG. 5. The short-term power of the output signals fⱼ(n) of the filters Sⱼ⁻¹(z) and of the estimated interference signal \hat{d}(n) is then estimated by power estimators 42. A power estimator 42 can, for example, be implemented as an exponential smoother that smoothes the squared input signal. The power estimates \hat{σ}_{f,j}² are then normalized 43 by their sum and then smoothed by a conditional smoother 50.

The conditional smoother 50 can be designed as shown in FIG. 7. In a step 51, an initialization is carried out first. In the following step 52, an input signal x and a trigger signal t are then entered. The trigger signal t is then compared with a threshold θ value by a comparator in a step 53. The current value y is held if the trigger signal t in the comparator is below a threshold value θ. Otherwise, the value y is updated in a step 54 according to the rule

$$y ← γ y + ( 1 - γ ) x \qquad ( 8 )$$

with the input signal x and the smoothing factor 0≤γy≤1. The held or updated value y is then output in step 55.

In the case of the process flow 40 shown in FIG. 6, the input signal x of the exponential smoother 50 corresponds to the output of the normalization 43 and the trigger signal t corresponds to the power estimate \hat{σ}_{\hat{d}}², so that the weighting factors gⱼ are only updated when a certain sound pressure level is present at the inner microphone. At a low level, the signal \hat{d}(n) has a poor signal-to-noise ratio, which would cause the weighting factors to jitter and cause audible artifacts. These artifacts are avoided by only performing the update when the level is sufficient.

Not all feedback filters Qⱼ(z) necessarily have to be implemented separately on a signal processor for fast filtering. Instead, the feedback filters can also be mixed on an external processor, such as a microcontroller or a smartphone, as shown in FIG. 8, in a process 60, e.g. using equation (2), to form a mixed feedback filter 61 Q̅(z) which is implemented on a signal processor for fast filtering Q(z) instead of the individual ones. Alternatively, the mixed feedback filter Qⱼ(z) can also be converted into a controller K(z) using equation (3) and operated in a classical control structure without an estimate of the secondary path 33.

FIG. 9 shows a variant of the feedback structure of FIG. 3 with an additional scaling 62 of the output signal of the mixed feedback filters, which scales the strength of the maximum attenuation. The scaling factor a can be adjusted to customer requirements using a scaling unit 62 either manually by users at runtime, by a calibration process or by experts, for example by audiologists as part of a service.

Furthermore, it is possible to calculate the scaling factor a automatically by a calculation unit, for example based on the signal of the inner microphone 22 or the input signal of the feedback filter. For example, the cross or autocorrelation function of these signals can be used to calculate the scaling factor.

The structure in FIG. 3 can also be expanded to include feedforward filters and the playback of external audio signals a(n). FIG. 10 shows this expanded structure. The signals from one or more outer microphones 22 are folded with a respective forward filter W(z) 63 and together form the forward signal. The filter W(z) can, for example, be designed in such a way that external sound signals x(n) are perceived as attenuated or transparent by users. Audio signals a(n) can be processed by an equalizer 64 to compensate for the tonal coloration through the loudspeaker 21 and the secondary path 32 on the way to the eardrum. If the forward filter 63 is designed to transparently sense external sound, then the intermediate signal supplied to the secondary path estimator 33 may be the sum of the forward signal, the output signal of the mixed feedback filters and the equalized external audio signal. This offers the advantage that the attenuation characteristics of the feedback loop have little effect on the forward signal and audio signal a(n). In this case, the intermediate signal is also fed to the loudspeaker 21.

As shown in FIG. 11, the acoustic model may further include an acoustic feedback path F(z) 65 from the loudspeaker 21 to the outer microphone 22 as well as a compensation 66 of the acoustic feedback 65, for example by an estimate \hat{F}(z) of F(z). In addition, the external audio signal a(n) can be the output signal of a hearing instrument 67, which has one or more microphones 68 and a processing unit 69. The processing unit 69 can use the signals from the microphones 68 of the hearing instrument as well as the signal 70 from the inner microphone 20 of the headphones. Furthermore, the tapping point 71 for the intermediate signal can be selected so that either only the output signal of the mixed feedback filters (switch position 3), the sum of the output signal of the mixed feedback filters and the equalized external audio signal a(n) (switch position 2) or the sum of the output signal of the mixed feedback filters, of the forward signal and the equalized external audio signal a(n) (switch position 1) is taken into account. For example, if the forward filter is designed to suppress noise, switch 71 is set to position 2 so that the closed control loop contributes to the active attenuation of external noise.

Based on the various embodiments described above, FIG. 12 shows a fully integrated system. This includes, for example, L outer microphones 22 with acoustic feedback paths 65 from the loudspeaker 21 of the headphones to the respective outer microphones 22.

Furthermore, the system includes estimates 66 of the acoustic feedback paths 65, which are each arranged so that they can compensate for the influence of the acoustic feedback paths. The signal supplied to the forward filters 63 can be selected via the switches 72. At switch position 1, the signal from the outer microphones 22 is used, whereas at switch position 2 the signal compensated by the estimates of the acoustic feedback paths is used. The system also has a processing unit 69, which implements the functionalities of a hearing instrument, and an equalizer 64 for equalizing external audio signals a(n). The feedback loop 34 contains the components already shown in FIG. 9 and described above, as well as the switch 71 for selecting the intermediate signal, which has also already been described. The acoustic model 30 explicitly shows the influence of a structure-borne sound signal d_{BC}(n), which is coupled into the ear canal 12 and recorded by the inner microphone 20. Although this signal is not shown in the other figures, this does not mean that structure-borne noise is not considered there.

In a further embodiment, the feedback filters can be mixed for different wearing situations or fittings of the headphones. In this case, the current fitting can be detected using a device in order to adjust the weighting factors 36 based on this. The adjustment of the weighting factors can also be carried out automatically so that a cost function is minimized.

In the embodiments described above, the mixing of the feedback filters is based on a signal that originates from a single signal source, such as an inner microphone. However, it is also possible to mix feedback filters that receive signals from different sources. For example, a feedback filter to which the signal of an inner microphone is fed can be mixed with a feedback filter to which the signal of an acceleration sensor or another microphone is fed. It is also possible that the filtering by the respective feedback filters is carried out at different sampling rates, wherein the output signals of at least one feedback filter must be subjected to a sampling rate conversion so that the output signals of the feedback filters can be mixed at a uniform sampling rate.

The disclosed apparatus can in particular be integrated into headphones, wherein such headphones can be designed in various ways. For example, these can be shell headphones, hearables, or so-called in-ear monitors, which are used, for example, by musicians or television presenters to check their own voice during live performances, or a combination of headphones and a mouth microphone to record speech in the form of a headset. The apparatus can also be part of a hearing aid or hearing protection. Finally, parts of the apparatus can also be part of an external device, such as a smartphone.

FIG. 13 shows schematically the basic concept for a method for active suppression for active noise and/or occlusion suppression, as can be carried out, for example, by means of an apparatus from FIG. 2. In the following, reference is made by way of example to the application of the method to headphones, but the method is not limited to this.

In the method, in a first step 90, a sound signal occurring in the ear canal of a user is recorded using at least one inner microphone of a headphone. This sound signal can include external noise or structure-borne noise, which may, for example, result from a voice output from the user wearing the headphones or impact sound from this user.

In a subsequent step 91, a combination signal is generated. For this purpose, two or more feedback filters are applied in a feedback loop to the signal generated by the inner microphone. As described above, the individual feedback filters have attenuation characteristics with different frequency responses, each of which is designed to suppress different sound components of the noise and/or the occlusion effect. The multiple feedback filters are combined by mixing, with the resulting attenuation characteristics being adjusted by weighting the individual feedback filters.

In the subsequent step 92, the compensation signal thus generated is then fed to a loudspeaker of the headphones and output by it.

In the case of a headphone that includes sound transducers for both ears of the user, the method described can be carried out separately for the two ears in order to enable the best possible compensation, for example if external noise hits the user's head from one side. However, the method can also be carried out jointly for the sound transducers of both ears.

1. Apparatus for active noise and/or occlusion suppression, comprising
an earpiece that can be coupled to a user's ear canal;
an inner microphone arranged in the earpiece and configured to detect a sound signal in the user's ear canal;
a loudspeaker arranged in the earpiece, which is configured to output a compensation signal into the user's ear canal, wherein noise and/or the occlusion effect can be reduced with the compensation signal;
a signal processor connected to the inner microphone and the loudspeaker to form a feedback loop and arranged
to apply two or more feedback filters or a feedback filter resulting from two or more feedback filters to an input signal in the feedback loop, wherein the individual feedback filters have different effects on the attenuation characteristics of the feedback loop and are each designed to suppress different sound components of the noise and/or the occlusion effect, wherein the two or more feedback filters are combined by a mixture;
to supply an intermediate signal generated by applying the two or more feedback filters or the feedback filter resulting from two or more feedback filters to the loudspeaker; and
to calculate the input signal supplied to the two or more feedback filters or the feedback filter resulting from two or more feedback filters from the signal of the inner microphone corrected by the intermediate signal filtered by a secondary path estimate.

2. Apparatus according to claim 1, wherein the mixing of the two or more feedback filters is carried out by the signal processor of the apparatus.

3. Apparatus according to claim 1, wherein the mixing of the two or more feedback filters is carried out by a digital processing device implemented in an external device.

4. Apparatus according to claim 1, wherein the resulting attenuation characteristics are adjusted by weighting the individual feedback filters.

5. Apparatus according to claim 1, wherein the apparatus comprises an equalizer for a reproduction of external audio signals by the loudspeaker, by which the external audio signals are processed and wherein the intermediate signal is generated from the output signal of the feedback filters combined by the mixing and the audio signal filtered by the equalizer.

6. Apparatus according to claim 1, wherein the apparatus comprises one or more forward filters to which the signals from one or more outer microphones are fed and wherein the output signals of the forward filter are taken into account when generating the intermediate signal and/or the compensation signal.

7. Apparatus according to claim 1, wherein the weighting of the individual feedback filters are set manually.

8. Apparatus according to claim 1, wherein the weighting of the individual feedback filters are automatically adjusted by a calculation unit.

9. Apparatus according to claim 8, wherein the calculation unit provides for each individual feedback filter a weighting function followed by a power estimate, which is then normalized and smoothed to calculate a weighting factor.

10. Apparatus according to claim 8, wherein the weighting factors for the individual feedback filters are calculated such that they add up to a predefined value.

11. Apparatus according to claim 10, wherein the calculated weighting factors are multiplied by a further factor and wherein this factor originates from a further calculation unit.

12. Apparatus according to claim 8, wherein it recognizes different wearing situations, in particular different ventilation, and the calculation unit adapts the weighting factors accordingly.

13. Apparatus according to claim 1, wherein the filtering of at least one of the feedback filters is carried out at a first sampling rate and the filtering of at least one further feedback filter is carried out at a second sampling rate different from the first sampling rate, and wherein the input and output signals of these filters undergo a sampling rate conversion.

14. Apparatus according to claim 1, wherein it is part of a headset, hearing aid or hearing protection.

15. A method for active noise and/or occlusion suppression, in which an earpiece is coupled to a user's ear canal, comprising:
detecting a sound signal occurring in the user's ear canal with an inner microphone arranged in the earpiece;
applying two or more feedback filters or a feedback filter resulting from two or more feedback filters to an input signal in a feedback loop, wherein the individual feedback filters have a different effects on the attenuation characteristic of the feedback loop and are each designed to suppress different sound components of the noise and/or the occlusion effect, wherein the two or more feedback filters are combined by a mixture, wherein the input signal supplied to the two or more feedback filters or the feedback filter resulting from two or more feedback filters is calculated from the signal of the inner microphone, corrected by the intermediate signal filtered by a secondary path estimate, and wherein an intermediate signal generated by the application of the two or more feedback filters or the feedback filter resulting from two or more feedback filters is supplied to the loudspeaker; and
outputting a compensation signal thus generated into the user's ear canal through a loudspeaker arranged in the earpiece, wherein the compensation signal is used to reduce noise and/or the occlusion effect.

16. A non-transitory storage medium comprising instructions for causing a computer to carry out the steps of a method according to claim 15.
